(19) United States
(12) Patent Application Publication
(10) Pub. No.: US 2012/0279930 A1
(43) Pub. Date: Nov. 8, 2012

(54) GREASE SEPARATION AND DISPOSAL SYSTEM

(75) Inventor: TERENCE R. ICETON, PENTICTON (CA)

(73) Assignee: CAR-KOR ENTERPRISES LTD., PENTICTON (CA)

(21) Appl. No.: 13/477,870

(22) Filed: May 22, 2012

(51) Int. Cl. B01D 29/90; B01D 37/00

(52) U.S. Cl. 210/767; 210/498; 210/257.1

(57) ABSTRACT

A grease separator includes a strainer bowl and funnel. The strainer bowl has a sieve in a lower surface. The funnel is mounted to the lower surface so as to depend downwardly from the bowl in fluid communication with the sieve apertures. The sieve apertures are aligned with, so as to all be in fluid communication with the upper end of funnel. The funnel forms a base under said bowl for stabilizing and supporting the bowl on a kitchen counter or storage cabinet surface. A disposable, biodegradable, grease-absorbing liner may be provided, cooperating in size with the funnel, so that the liner snugly mounts into a reusable heat-resistant container, the funnel inserts into the open upper end of the liner, and the grease is poured into and captured by the liner and the container. The liner is then removed for disposal.

### FIELD OF THE INVENTION

This invention relates to the field of grease separators and grease collectors, and in particular to a grease separator and disposal system wherein a modified strainer includes a funnel portion adapted for insertion into a reusable container having a disposable liner.

### BACKGROUND OF THE INVENTION

Disposal of typical kitchen fat, oil and grease, conventionally, and herein referred to as FOG, which is encountered within residential kitchens when, for example, cooking fatty foods is inconvenient, often messy, and may be environmentally unsound if the waste grease is not disposed of properly.

In an informal polling of people's habits in this regard, applicant found that a significant percentage of people polled merely poured their waste grease down the kitchen drain while running hot water into the drain. Others poured kitchen grease from the pot or frying pan into an empty tin can, glass jar, plastic container or other recyclable container. The pouring of waste grease down the kitchen plumbing and so that it may eventually reach the sewer system or septic tank is clearly improper in that it may cause a blockage in the plumbing as the grease congeals and, for the grease which exits the residential plumbing into the civic sewer system or septic tank, may accumulate and cause blockages downstream. The disposal of waste grease by pouring the waste grease into an empty tin can or other recyclable container usually means that the container must be left on the kitchen counter or the like in order for it to cool before it may be disposed of typically whereby leaving lingering odours in the kitchen long after the cooking and cleanup has been finished. Further, congealed grease in recyclable containers complicates the recycling process for the container in that the container has been fouled by the refilling with a waste FOG product. Applicant believes that fouled otherwise recyclable containers will often be refused for recycling, and will become landfill waste.

Further, if the waste kitchen grease is to be stored in a container for the later addition of additional waste FOG until the container is full before the container is disposed of, the problem of odours and potentially a problem of attracting insects and pests are compounded.

Various methods and apparatus have been proposed is the prior art for FOG or grease separation, collection and disposal, for example as found in U.S. Pat. Nos. 7,731,846 and 8,016,150.

In U.S. Pat. No. 7,731,846, which issued Jun. 8, 2010, to Jones for A Grease Collection System, a grease collection system for collecting and storing cooking grease for disposal by a user is proposed wherein liquid cooking grease is poured by a user into an inlet assembly coupled to a cabinet. The grease flows through the inlet assembly and into a grease collector via a hose. A funnel is provided to engage the inlet assembly to facilitate pouring of the cooking grease into the inlet assembly. The collector is positioned on the floor of the cabinet, and the inlet is illustrated as mounted adjacent a sink. A cleaner is provided to clear blockages in the hose between the inlet and the collector. The collector is taught to include a canister having a disposable bag mounted therein. Jones states that his grease collection system is a closed system in the sense that all fluids and debris that enter into the system through the inlet assembly are collected in the collection assembly. The funnel is taught to threadably engage into the inlet assembly so as to inhibit the funnel from inadvertently disengaging when the user is pouring cooking grease into the funnel. A meat draining member may be selectively coupled to the funnel.

U.S. Pat. No. 8,016,150 which issued Sep. 13, 2011, to Bunch et al. for a Used Cooking Grease Disposal And Storage Device, discloses a receptacle which is positioned within the cavity of a container. The receptacle may be a disposable bag. A funnel is positioned within the container cavity and stabilized by a support so as to align the funnel with the receptacle to thereby guide a disposable substance such as grease through the funnel and into the receptacle in the container. The support is removable from the container so as to provide access to the receptacle for disposal. A removable strainer may be positioned within the funnel to catch any food items or other items not desired to be deposited within the receptacle.

### SUMMARY OF THE INVENTION

The present invention provides, in one aspect, a modified strainer or modified colander, herein collectively referred to as a strainer, which includes a receiving bowl having straining apertures and a funnel mounted thereunder. The bowl is large enough, for example a four cup size, to capture cooked food product and liquid FOG when poured into the modified strainer from, for example, a large frying pan or large pot. The funnel is preferably rigid, although this is not intended to be limiting, and may be cylindrical in shape or may be conical or frusto-conical in shape, with the narrower end, if any, disposed at the lowermost end of the funnel. The strainer is modified in the sense that the straining apertures or sieve apertures (collectively herein referred to as sieve apertures) in the bowl of the strainer are positioned so as to be only directly over the open upper end of the funnel. The walls of the bowl do not have apertures. Thus fluids such as liquid FOG being poured into the strainer bowl flow through the sieve apertures and into the open upper end of the funnel, and otherwise do not escape from the strainer bowl. FOG passing through the sieve apertures and into the upper end of the funnel exit from the lower end of the funnel. The lower end of the funnel has been inserted into the open upper end of a disposal container. The modified strainer according to the present invention is advantageously sized to be a substitute for a conventional strainer or colander, so that the conventional strainer or colander may be entirely replaced with the modified strainer, thereby not increasing the clutter in the kitchen cupboards or drawers. The modified strainer may be used as a conventional strainer even though counter-intuitively there are no sieve apertures in the bowl walls as found in conventional colanders.

The funnel is advantageously sized so that at least the lower end of the funnel fits into the most common forms of disposal containers including recyclable containers such as tin cans and for example one-half litre wax-paper milk cartons, when the top of the carton has been fully opened. This allows the use of the modified strainer according to the present invention to reduce the mess and inconvenience previously found when pouring grease, for example from a large frying pan into a disposal container such as a wax paper carton or recyclable container which has a relatively small upper opening.

In a preferred embodiment, the modified strainer is used as a system in conjunction with a disposable liner, for example a waxed paper liner somewhat similar in shape to a conical or basket-style coffee filter used in drip coffee makers. The liner is intended to be a low cost disposable liner which is preferably biodegradable and which is easily inserted by the user into any suitable smallish container. For example such a smallish container may be a coffee mug or the like which supports the disposable liner when the liner is mounted snugly into the mug. The user holds the strainer apparatus with one hand, and with the other hand pours the contents of, for example, the frying pan into the strainer bowl with the lower end of the funnel inserted into the upper open end of the liner.

Applicant has found that waxed paper liners will not soak the hot liquid grease or other FOG into the paper of the liner. Applicant has found that the grease will not penetrate or migrate significantly or at all from the liner. The liner is sized and mounted in the container so as to snugly line against and around the walls and bottom of the container. The grease then congeals, after which the paper liner may be easily slid out of the container carrying the grease with it, for disposal into the garbage as conventional biodegradable kitchen waste.

In alternative embodiments, the liner need not be waxed paper so long as the liner is disposable and of low cost, and in a preferred embodiment as stated above is biodegradable in the landfill. In yet further embodiments, the liner is sufficiently stiff and formed to be self supporting when for example sitting on a kitchen counter so that the liner becomes a disposable container in and of itself, removing the need to use further containers such as a coffee mug. Thus for example a wax-paper carton may be employed.

In embodiments using liners which are removable from correspondingly sized containers, it is advantageous if the liner is taller than the container so that, as illustrated herein, the upper edges of the liner protrudes above the upper lip of the container. This allows a user to easily gather together the upper edges of the liner once the grease has congealed, so as to smoothly, with an upwardly pulling motion, extract the liner from the container. Where for example the container is a coffee mug or the like, the coffee mug may then be easily washed to remove any film of grease which may have seeped from the liner.

### BRIEF DESCRIPTION OF THE DRAWINGS

In the drawings wherein similar characters of reference denote corresponding parts in each view:

FIG. 1 is a top perspective view of one embodiment of the grease separator.

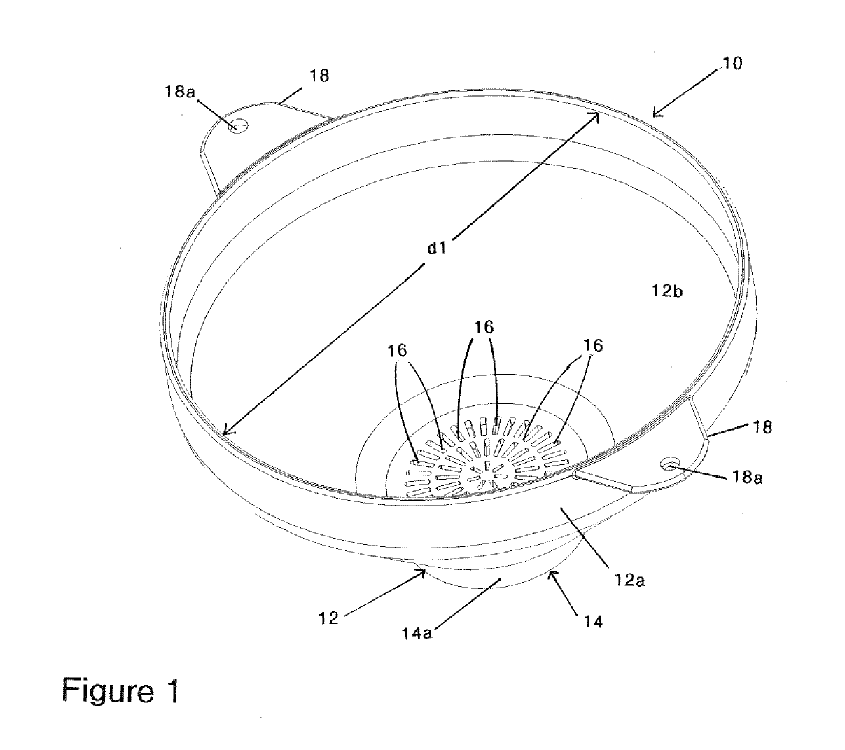

FIG. 2 is a bottom perspective view of the grease separator of FIG. 1.

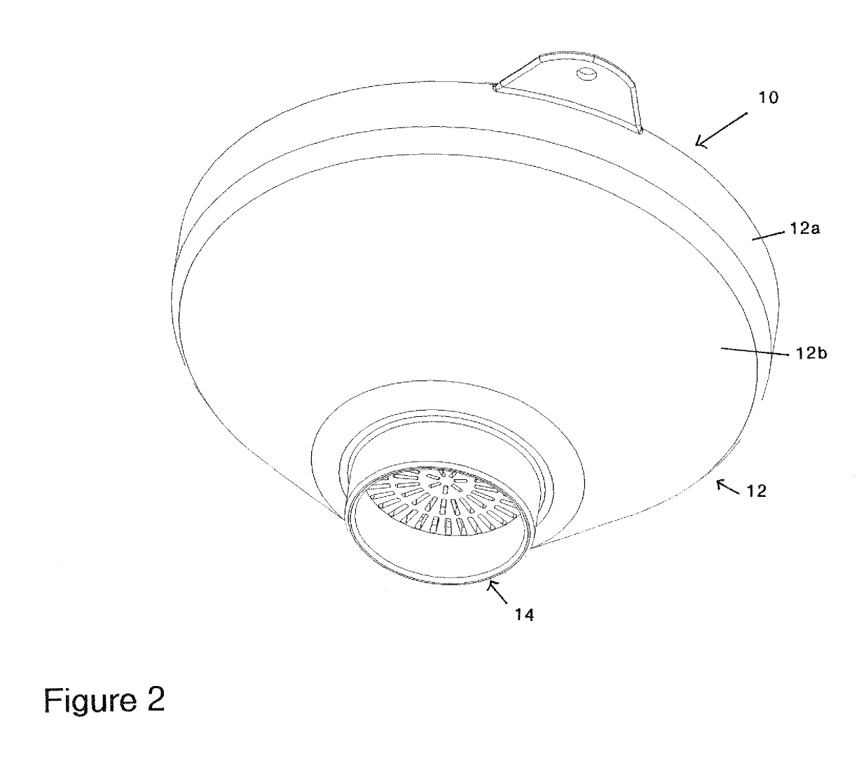

FIG. 3 is a side elevation view of the grease separator of FIG. 1.

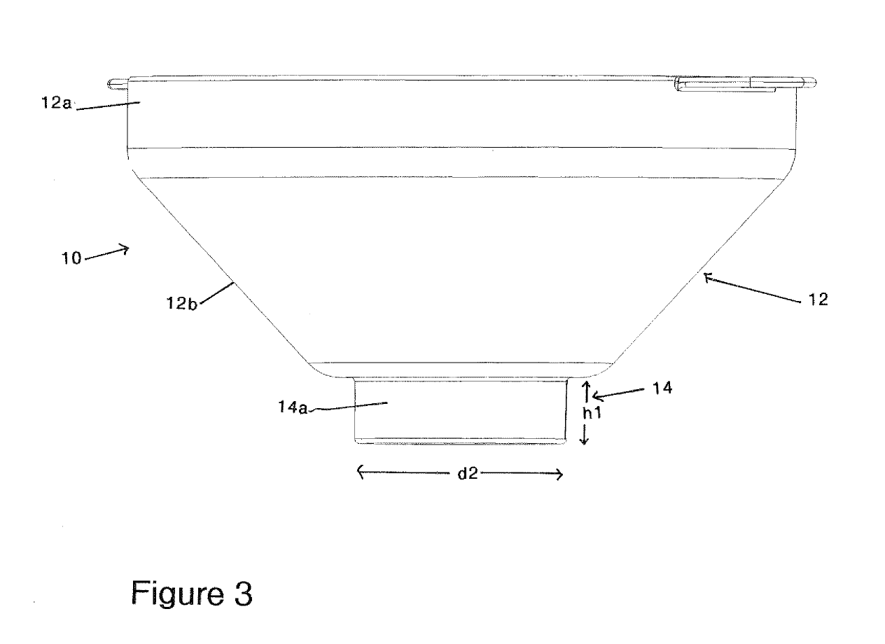

FIG. 4 is, in partially exploded bottom perspective view, the grease separator of FIG. 1 shown with its funnel portion nested into the upper opening of a disposable liner, wherein the disposable liner is nested into a hollow container.

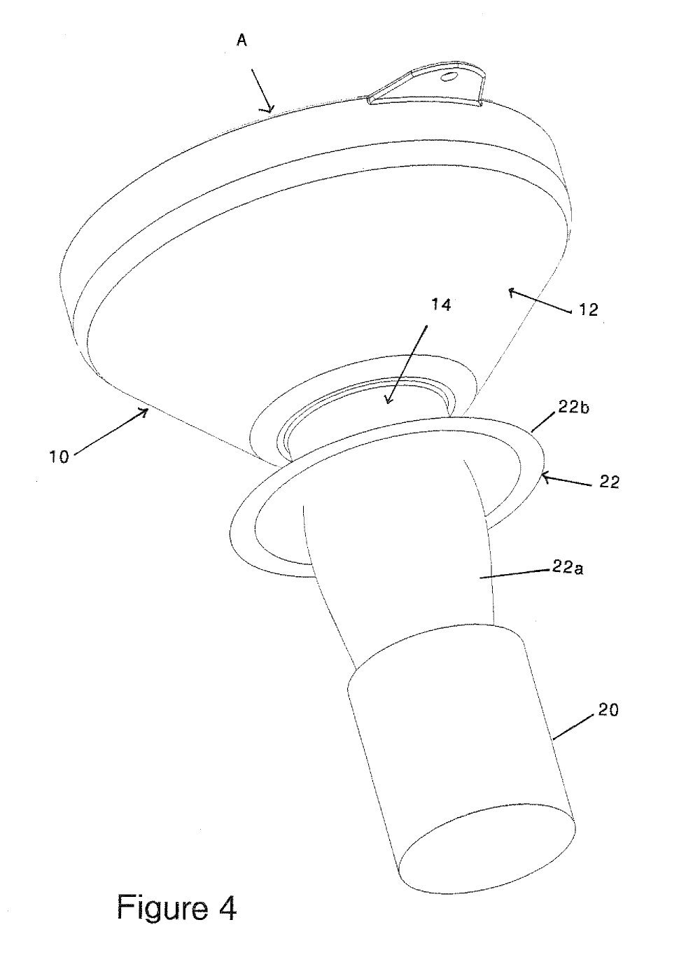

FIG. 5 is, in partially exploded top perspective view, the system of FIG. 4.

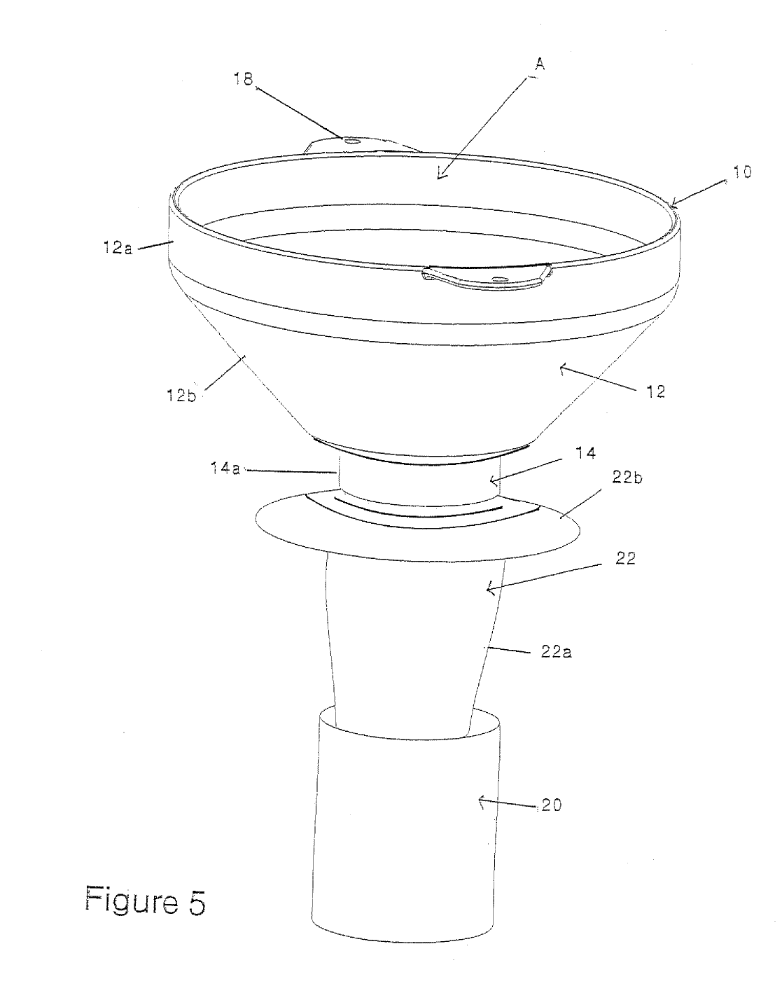

### DETAILED DESCRIPTION OF EMBODIMENTS OF THE INVENTION

As seen in the figures which accompany this specification, and form a part thereof, the grease separation system according to one aspect of the present invention includes a grease separator 10 which includes an upper bowl portion 12 and a lower funnel portion 14. Although bowl portion 12 is illustrated as having an upper cylindrical rim 12a adjoining a lower frusto-conical catchment basin 12b it is understood that bowl portion 12 is not intended to be so limited in shape. Bowl portion 12 may be semi-spherical in shape, or may be otherwise shaped including having a platter-like shape, or a box-like shape, or an irregularly curved shape. The upper opening into the bowl portion 12 may be formed as a circle, or ellipse, or a square or rectangle, or some combination of these, or may be irregularly shaped so as to accommodate a particular size and shape of pan or pot or other cooking container in which food is heated so as to liquefy the FOG contained in the food and produce liquefied FOG. Thus advantageously, the rim 12a of bowl portion 12 will define an upper diameter d₁ which may for example be greater than or equal to 7 inches, or may for example be in the range of 7-12 inches, although this is not intended to be limiting. Advantageously, diameter d₁ should be sufficiently large to accommodate wide-mouthed frying pans and pots so that when grease is being poured from the frying pan or pot into grease separator 10, the likelihood of liquefied grease spilling to the outside of rim 12a is reduced.

A plurality of sieve apertures 16 are formed in the lowermost end of basin 12b so as to pass liquid grease there-through. Sieve apertures 16 are small holes in the basin, for example having a diameter of one to several millimetres. Apertures 16 are formed directly above, so as to fall within, the circumferential boundary of funnel portion 14 as defined by the walls 14a of the funnel. Again, although funnel portion 14 is illustrated to be a hollow cylinder having a height h₁ which is much less than the corresponding funnel diameter d₂, it is understood that the shape and dimensions of funnel portion 14 are not intended to be so limited. In alternative embodiments, funnel portion 14, instead of being circular in horizontal cross section, may be otherwise shaped, for example, elliptical, square or rectangular, or a combination of these, or irregularly shaped. Funnel portion 14 may itself be conical in shape or frusto-conical.

Advantageously, height hi may, as seen in the drawings, be approximately ⅝ of an inch, or for example may be in the range of ½ to two inches. A lower height hi may be preferable because a secondary function for funnel portion 14 is to provide a stand or base. Grease separator 10 sits in a stable position on the base provided by funnel portion 14 when resting on a horizontal flat surface, for example a kitchen counter, or on a cabinet shelf when grease separator 10 is stowed. This advantageously allows for the use of grease separator 10 to replace conventional strainers or colanders and thus, by substituting grease separator 10 for conventional strainers or colanders, the use of a grease separator 10 does not require additional storage space within a kitchen, which is often at a premium. Even though basin 12b lacks straining aperture around its walls, grease separator 10 may function as a conventional strainer or colander for straining typically water based liquids from cooked items. Apart from the structure described above wherein the sieve or straining apertures 16 are constrained to be within the circumference of the funnel walls 14a so that all of the sieve apertures 16 are within fluid communication within the interior of funnel portion 14, grease separator 10 must be made of a heat resistant material often not found in conventional kitchen strainers or colanders which may be made of rather soft and non-heat-resistant plastics.

The diameter of funnel 14, and in particular diameter d₂, may advantageously be within the range of approximately one to three inches. Thus funnel portion 14 may be for example two times as high as it is wide, although this may not be preferable as the support or base function provided by funnel portion 14 would thereby be undermined, as grease separator 10 would be not particularly stable when resting on the lowermost end of the funnel portion. Conversely, and as illustrated, funnel portion 14 may be three times as wide as it is high.

Conventional handles 18 may be provided mounted to for example opposite sides of rim 12a, so as to protrude therefrom for ease of holding of grease separator 10 by a user. One or more of handles 18 may include holes 18a for storing grease separator 10 from for example a hook within a kitchen cabinet, or from a nail protruding from a wall.

The width or diameter d₂ is preferably chosen to match the size of the opening of the desired grease capture container 20. Thus if the grease catcher container 20 is for example an empty tin can, for example an empty soup can, the size of the opening into the can may be in the range of 2-4 inches in diameter. Thus diameter d₂ will be sized so that the lower end of funnel portion 12 may be easily inserted into the open end of the grease capture container. Similarly, if the desired grease capture container is a wax-paper carton for example of the kind often found storing milk, then, with the top of the empty carton fully opened, typically the diameter of the opening will be similar to that found for tinned goods, that is, in the range of 2-4 inches. Again, the lowermost end of funnel portion 12 would be sized as to fit into the open end of the grease capture container 20.

In the system according to a further aspect of the present invention, a grease capture container liner 22 is provided which inserts into grease capture container 20 prior to funnel portion 14 being inserted. For example, liner 22 may be a waxed paper cup product. Advantageously, liner 22 is sized so that it snugly and conformally fits into the cavity within grease capture container 20. Thus, if liner 22 is made of waxed paper, and the insert portion 22a is sized to snugly fit within grease capture container 20, then, with funnel 14 inserted into the open upper end of liner 22, and with liner 22 within grease capture container 20, FOG that is poured in direction A into bowl portion 12 is strained by sieve apertures 16 and flows downwardly through funnel 14 and into insert portion 22a. Debris within the liquefied FOG poured into bowl portion 12, is captured by sieve apertures 16, so long as the size of the debris being strained is larger than the largest diameter or opening dimension of the sieve apertures 16. Liquid FOG, once strained, flows downwardly from funnel 14 and is captured and held by the waxed paper walls and base of insert portion 22a. Once all of the liquid FOG is decanted into bowl portion 12 and allowed to flow down into insert portion 22a within grease capture container 20, grease separator 10 may then be removed and the upper circumferential edges 22b of liner 22 gathered upwardly. The top of the liner may be closed, for instance, by the use of a, plastic clip, twist tie or other means of closing the upper edges 22b of liner 22. Liner 22 is then left within grease capture container 20 until the liquid grease has congealed. Once the grease has congealed, the gathered upper circumferential edges 22b may be pulled gently upwardly so as to release the contact between the sidewalls of grease capture container 20 and insert portion 22a of liner 22 to thereby allow the liner 22 to be lifted clear from grease capture container 20 for disposal of the liner and its contents. The liner 22 containing the waste grease may be disposed into the conventional waste which is ultimately deposited at a municipal landfill. Both the liner and the waste grease are biodegradable. Grease capture container 20, which may be for example as common an object as a coffee mug, mason jar, empty tin can or the like, is then simply washed if it is a coffee mug or the like to be reused within the kitchen. If container 20 is an empty tin can, then the tin can may be stored for later reuse with a new liner 22 for the next time waste cooking FOG is to be captured from under grease separator 10, or the tin can may be recycled as it has not been fouled by waste FOG as it conventionally would have been were it not for the operation of the system according to the present invention. That is, both the FOG and the liner are biodegradable and will prevent recyclable items from being contaminated and ending up in the land fill.

Once the grease separation has been completed, a user merely places grease separator 10 into the kitchen sink where it rests stably upon the base provided by the horizontal lowermost edges of funnel walls 14a while the user than deals with for example liner 22. The debris or food products caught within bowl portion 12 by sieve apertures 16 may then be dealt with. For example food products may be recovered and returned to the frying pan or pot, or the debris may be otherwise disposed of into the waste. Grease separator 10 may then be simply washed as would be any strainer or colander for later reuse.

While washing the separator, very small amounts of FOG will end up going into the home or commercial kitchen sewer line. The minute amounts will be mixed with hot water and detergent to help in its journey through the sewer lines. By drastically reducing or eliminating the larger amounts of FOG from entering the domestic, commercial and civic sewer system, it will reduce the maintenance costs for all.

As will be apparent to those skilled in the art in the light of the foregoing disclosure, many alterations and modifications are possible in the practice of this invention without departing from the spirit or scope thereof. Accordingly, the scope of the invention is to be construed in accordance with the substance defined by the following claims.

What is claimed is:

1. A grease separator comprising:
a strainer bowl having a plurality of sieve apertures in a lower surface of said bowl,
a funnel mounted to said lower surface so as to depend downwardly from said bowl, said funnel in fluid communication with said plurality of sieve apertures, wherein said funnel has an open upper end, and wherein all of said plurality of sieve apertures are aligned with so as to be within said fluid communication with said upper end of said funnel,
wherein said funnel has an open lower end, opposite to said upper end, said open lower end having a diameter, said funnel having a height extending from an uppermost edge of said upper end to a lowermost edge of said lower end, and wherein said funnel forms a base under said bowl for supporting said bowl on a flat horizontal surface, and wherein said height is substantially within the range of one half inch to three inches, and wherein said diameter is substantially in the range of one-three inches.

2. The grease separator of claim 1 wherein said funnel is substantially cylindrical.

3. The grease separator of claim 1 wherein said funnel is substantially conical, and wherein said diameter of said upper end is greater than said diameter of said lower end.

4. The grease separator of claim 3 wherein said funnel is frusto-conical.

5. The grease separator of claim 1 wherein said bowl has an upper rim therearound and wherein said upper rim of said bowl is substantially in the range of six-twelve inches diametrically across.

6. The grease separator of claim 1 wherein said diameter is no less than substantially two inches.

7. The grease separator of claim 6 wherein said diameter is substantially three inches.

8. The grease separator of claim 3 wherein said diameter of said lower end is no less than substantially two inches.

9. The grease separator of claim 8 wherein said diameter of said lower end is substantially three inches.

10. The grease separator of claim 1 wherein said height is no less than substantially two inches.

11. The grease separator of claim 10 wherein said height is substantially three inches.

12. The grease separator of claim 1 further comprising a disposable liner which is sized for snug mounting into a grease capture container.

13. The grease separator of claim 12 wherein the grease capture container has a height, a width and a depth, and wherein said liner is sized so that, when in a open position, said liner has a corresponding height, width and depth substantially corresponding to said height, width and depth of said container so as to said snugly line said container when removably mounted therein.

14. The grease separator of claim 13 wherein said height of said liner is greater than said height of said container.

15. A method for separating grease comprising:
a) providing a strainer bowl having a plurality of sieve apertures in a lower surface of said bowl, wherein a funnel is mounted to said lower surface so as to depend downwardly from said bowl, said funnel in fluid communication with said plurality of sieve apertures, wherein said funnel has an open upper end, and wherein all of said plurality of sieve apertures are aligned with so as to be within said fluid communication with said upper end of said funnel, wherein said funnel has an open lower end, opposite to said upper end, said open lower end having a diameter, said funnel having a height extending from an uppermost edge of said upper end to a lowermost edge of said lower end, and wherein said funnel forms a base under said bowl for supporting said bowl on a flat horizontal surface, and wherein said height is substantially within the range of one-three inches, and wherein said diameter is substantially in the range of one-three inches,
b) providing a disposable liner which is sized for snug mounting into a grease capture container,
a) c) snugly mounting said liner in said grease capture container so as to line said container with said liner and so as to form an opening into said liner which is open upwardly,
d) positioning said lower end of said funnel into said opening into said liner, and so as to dispose said bowl above said grease capture container,
e) pouring liquefied grease into said bowl and through said plurality of sieve apertures so to dispose liquid grease of said liquefied grease into said liner vial said funnel, and so as to strain solids from said liquefied grease at said plurality of sieve apertures,
f) removing said funnel from said opening into said liner, and lifting said liner containing said grease from said container and thereafter disposing of said liner and said grease.

16. The method of claim 15 further comprising allowing said liquid grease to congeal in said liner before said lifting of said liner from said container.

17. The method of claim 16 wherein a height of said liner is greater than a height of said container, and wherein a user gathers together an upper end of said liner during said lifting of said liner from said container so as to release sides of said liner from viscous attachment to corresponding sides of said container by an upward pulling of said liner following said gathering of said liner.

18. The method of claim 17 wherein said liner is a waxed paper liner.

19. The method of claim 17 wherein said liner is not absorbent so as to not absorb said liquid grease prior to said grease congealing.

20. The method of claim 15 wherein said funnel is substantially cylindrical.

21. The method of claim 15 wherein said funnel is substantially conical, and wherein said diameter of said upper end is greater than said diameter of said lower end.

22. The method of claim 21 wherein said funnel is frusto-conical.

23. The method of claim 15 wherein said bowl has an upper rim therearound and wherein said upper rim of said bowl is substantially in the range of six-twelve inches diametrically across.

24. The method of claim 15 wherein said diameter is no less than substantially two inches.

25. The method of claim 15 wherein said diameter is substantially three inches.

26. The method of claim 21 wherein said diameter of said lower end is no less than substantially two inches.

27. The method of claim 26 wherein said diameter of said lower end is substantially three inches.

28. The method of claim 15 wherein said height is no less than substantially one half inch.

29. The method of claim 28 wherein said height is substantially in the range of one half inch to three inches.

30. The method of claim 15 further comprising a disposable liner which is sized for snug mounting into a grease capture container.
